(19) United States
(12) Patent Application Publication
(10) Pub. No.: US 2013/0030621 A1
(43) Pub. Date: Jan. 31, 2013

(54) DISCHARGE TECHNIQUE FOR RESIDUAL HIGH VOLTAGE IN HYBRID VEHICLE AND METHOD THEREOF

(71) Applicants: Tae Young Chung, Hwaseong (KR); Daeki Hong, Hwaseong (KR)

(72) Inventors: Tae Young Chung, Hwaseong (KR); Daeki Hong, Hwaseong (KR)

(73) Assignees: KIA MOTORS CORPORATION, Seoul (KR); HYUNDAI MOTOR COMPANY, Seoul (KR)

(21) Appl. No.: 13/314,952

(22) Filed: Dec. 8, 2011

(30) Foreign Application Priority Data
Jul. 28, 2011 (KR) 10-2011-0075159

(51) Int. Cl. B60W 20/00; B60W 10/26; H02P 7/00

(52) U.S. Cl. 701/22; 318/139

(57) ABSTRACT

Disclosed is a technique for discharging a residual high voltage of a hybrid vehicle that includes a high voltage battery and a battery controller controlling the high voltage battery, a high voltage DC-DC converter connected to the high voltage battery to charge or discharge the high voltage battery, and a motor controller connected to the high voltage DC-DC converter to control a motor. A discharge control unit is connected to the motor controller to discharge the residual high voltage through the motor, and a shutdown control unit turns off the high voltage DC-DC converter and the motor controller when the discharge control terminates.

### CROSS-REFERENCE TO RELATED APPLICATION

This application claims priority to and the benefit of Korean Patent Application No. 10-2011-0075159 filed in the Korean Intellectual Property Office on Jul. 28, 2011, the entire contents of which are incorporated herein by reference.

### BACKGROUND OF THE INVENTION

(a) Field of the Invention

The present invention relates to a system for discharging a residual high voltage of a vehicle, and a method thereof. More particularly, the present invention relates to a system for discharging a residual high voltage of a hybrid vehicle operating a motor, and a method thereof.

(b) Description of the Related Art

Conventionally, in the case of a fuel cell vehicle, when a maintenance checkup is necessary for a fuel cell vehicle that is provided with a fuel cell “supercap” system including a braking register, a chopper, a “supercap”, etc., a separate signal is input from a driver to turn on a discharge switch of a chopper to a duty of 100% before turning off vehicle operation, after which electrical energy of the “supercap” is reduced through a braking register, and until the voltage thereof is reduced to a predetermined value, the chopper control discharges the “supercap”. This embodiment is described in Korean Patent Laid-Open Publication No. 2008-0054292 which is hereby incorporated by reference.

Further, in Korean Patent No. 0802679, which is also incorporated by reference, when a hybrid vehicle is turned off, a system for discharging DC link voltage from a hybrid inverter is used. In particular, DC link voltage is charged to a 12V auxiliary battery to be discharged through a logic unit that transfers a signal for discharging voltage to an LDC (low voltage DC-DC converter) from a motor controller (MCU).

A discharge method DC-DC converter switching such as a conventional LDC can reduce time (to within seconds) and heat generation in comparison with a discharge method which uses a passive element (i.e., which may take several tens of seconds to several hundred seconds) such as a discharge resistor. However, when capacity of an inner capacitor is large, and the capacity of 12V battery is small, or an amount of energy consumption of the electronic devices is small, the time thereof can be increased and the heat generation can also be increased in the above described embodiments.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and a method thereof having advantages of preventing a driver and a vehicle operator from being exposed to a dangerous condition during, e.g., maintenance of a high voltage component or a vehicle collision, by discharging a residual high voltage between hybrid high voltage components through a motor.

A system for discharging a residual high voltage of a hybrid vehicle according to an exemplary embodiment of the present invention may include a high voltage battery and a battery controller configured to control the high voltage battery, a high voltage DC-DC converter (HDC) that is connected to the high voltage battery to charge or discharge the high voltage battery, a motor controller that is connected to the high voltage DC-DC converter to control at least one motor, a discharge control unit that is connected to the motor controller to discharge the residual high voltage through the motor, and a shutdown control unit that turns off the high voltage DC-DC converter and the motor controller when the discharge control terminates.

The discharge control unit may include a discharge control performance determiner that selects a motor for performing discharge control when two motors are disposed in the vehicle. The discharge control unit includes a discharge control ending unit that compares the discharge time and an inner residual voltage with a predetermined value and terminates the discharge control. The shutdown control unit may be configured in some embodiments to terminate operation of the motor controller and control of the high voltage DC-DC converter to complete a shutdown sequence.

A method for discharging a residual high voltage of a hybrid vehicle according to an exemplary embodiment of the present invention may include determining that the vehicle is turned off, blocking input and output power from a high voltage battery, discharging a residual high voltage by closing a discharge switch of a high voltage DC-DC converter, and controlling shutdown, when the discharge control terminates. Furthermore, the residual high voltage may be discharged by operating at least one motor. It may be determined which of motor is to be operated, before the residual high voltage is discharged in vehicles in which more than one motor is installed.

The system may also be configured to determine whether the discharge time is longer than a predetermined value, while the residual high voltage is discharged, and whether a residual voltage is larger than a predetermined value, when the residual high voltage is discharged.

In some exemplary embodiments of the present invention, the shutdown control may terminate current control of the motor controller and control of the high voltage DC-DC converter, and may turn off the motor controller and the high voltage DC-DC converter accordingly.

An exemplary embodiment of the present invention uses a motor to reduce the discharge time to within several milliseconds and reduce heat generation at the same time. Furthermore, the present invention also can control the amount of voltage discharged per hour in a system in which a capacitor of a large capacity is applied so that the discharge time can be reduced.

Also, because an internal residual high voltage that is to be discharged is an energy source, the system can enter into a power off condition directly after the discharge control is completed. Further, when a hybrid vehicle uses at least two motors, the discharge control can be performed through just one of the motors, even if one motor or a controller thereof has a problem.

### BRIEF DESCRIPTION OF THE DRAWINGS

The above and other objects and features of the present invention will become apparent from the following description of embodiments given in conjunction with the accompanying drawings, in which:

FIG. 1 is a schematic diagram of a system according to an exemplary embodiment of the present invention.

FIG. 2 is a flowchart showing discharge control according to an exemplary embodiment of the present invention.

FIG. 3 is a control flowchart in a discharge control performance determiner and a discharge control end determiner according to an exemplary embodiment of the present invention.

FIG. 4 is a control flowchart in a shutdown control unit according to an exemplary embodiment of the present invention.

### DETAILED DESCRIPTION OF THE EMBODIMENTS

Hereinafter, with reference to the accompanying drawings, the present invention will be described in order for those skilled in the art to be able to implement the invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum) with a motor installed therein. As referred to herein, a hybrid vehicle is a vehicle that has two or more sources of power, for example both gasoline-powered and electric-powered vehicles.

Illustratively, the exemplary embodiment of the present invention includes a system, method, apparatus and computer readable medium for discharging a residual high voltage of a hybrid vehicle according to an exemplary embodiment of the present invention by using a motor to quickly discharge a residual high voltage without significant heat generation.

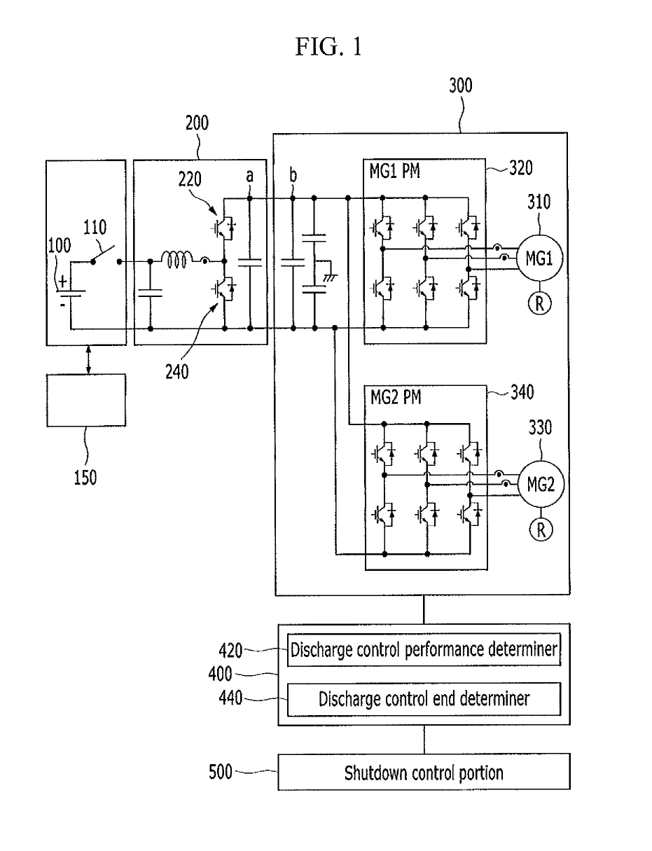

FIG. 1 is a schematic diagram according to an exemplary embodiment of the present invention, and hereinafter this invention will be described with reference to this. The system includes a battery controller 150 that controls charging and discharging of a high voltage battery 100 and a high voltage battery 100, a high voltage DC-DC converter 200 connected to the high voltage battery 100 to boost or drop a voltage thereof so that the high voltage battery 100 is charged or discharged, a motor controller 300 connected to the high voltage DC-DC converter 200 to operate at least one motor so that a residual high voltage is discharged, a discharge control unit 400 configured to discharge of the residual high voltage, and a shutdown control unit 500 configured to shut down the high voltage DC-DC converter 200 and the motor controller 300 when the discharge control terminates.

The high voltage battery 100 includes a main relay 110 selectively either connects or blocks the input and output of power, and the battery controller (e.g., a battery management system, BMS) 150 controls the main relay 110 to charge or discharge the high voltage battery 100. The BMS 150 detects voltage, current, temperature, etc. of the high voltage battery 100 to control an SOC (state of charge) and a charging and discharge current amount, and transfers the related information to a main control unit, e.g., an HCU (hybrid control unit).

Also, the high voltage DC-DC converter 200 includes a plurality of power modules such as a charging switch 240 and a discharge switch 220. The motor controller 300 is connected to the high voltage DC-DC converter 200 and includes a first motor power module 320 and a second motor power module 340 including power modules such as a plurality of transistors and diodes.

At least one motor is necessary for discharge according to an exemplary embodiment of the present invention, and two motors are prepared in an exemplary embodiment of the present invention, although the invention is not limited thereto. The two motors are a first motor 310 and a second motor 330 that are operated by the first motor power module 320 and the second motor power module 340. When several motors are installed, one of the motors is selected, and a discharge control performance determiner 420 performs the selection function. However, two motors can be used to perform the discharge at the same time as well.

Also, while the discharge is being performed through the first motor 310 and the second motor 330, the current magnitude flowing to each motor is monitored. Advantageously, when a high current is discharged through the first and second motors 310 and 330, less time is necessary to discharge, but as the current magnitude is increased, heat generation may increase as well, therefore the discharge amount per hour can be adjusted by controlling the discharged current magnitude to be within a predetermined range. Also, the discharge control unit 400 is connected to the motor controller 300 to be able to control the motors 310 and 330.

While the discharge control is being performed, the discharge time and the inner residual voltage are compared with predetermined values (Tₚ, Iₚ) within the system, and when a predetermined time (Tₚ) has passed, it can be assumed that the main relay 110 of the high voltage battery 100 is closed and this comparison prevents this condition from occurring. The inner residual voltage is compared with the predetermined value (Iₚ) because it is not necessary to discharge the battery when the voltage is lower than the predetermined value (Iₚ). The discharge control according to an exemplary embodiment of the present invention uses the inner residual high voltage of the battery that is to be discharged as an energy source. Directly after the discharge control ends, the system can enter into a power-down stage. The residual voltage in the above embodiment signifies an input side high voltage (voltage of ‘a’ point of FIG. 1, Vₐ) of a high voltage DC-DC converter 200 and an input side high voltage (voltage of ‘b’ point of FIG. 1, V_{b}) of a motor controller 300.

Hereinafter, a procedure for discharging a high voltage that remains within a hybrid vehicle according to an exemplary embodiment of the present invention will be more specifically described. In accordance with an exemplary embodiment of the present invention, when an ignition is turned off, the discharge procedure is performed without a further operation regardless of the driver's intention, and the discharge procedure is also performed when a collision is detected or a high voltage input connector is disconnected.

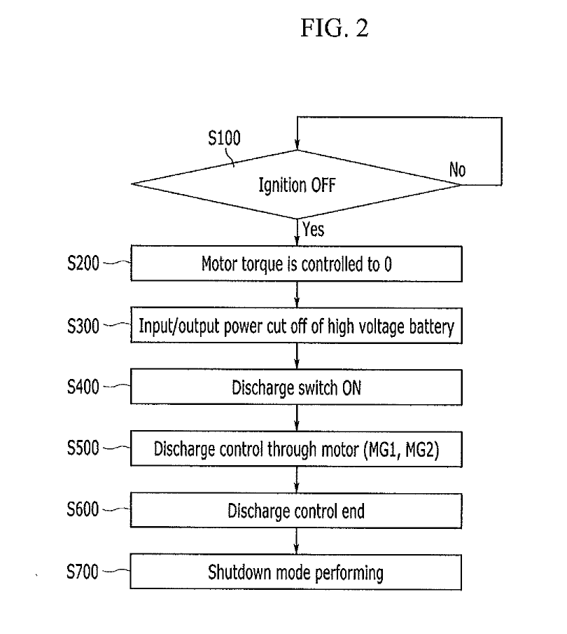

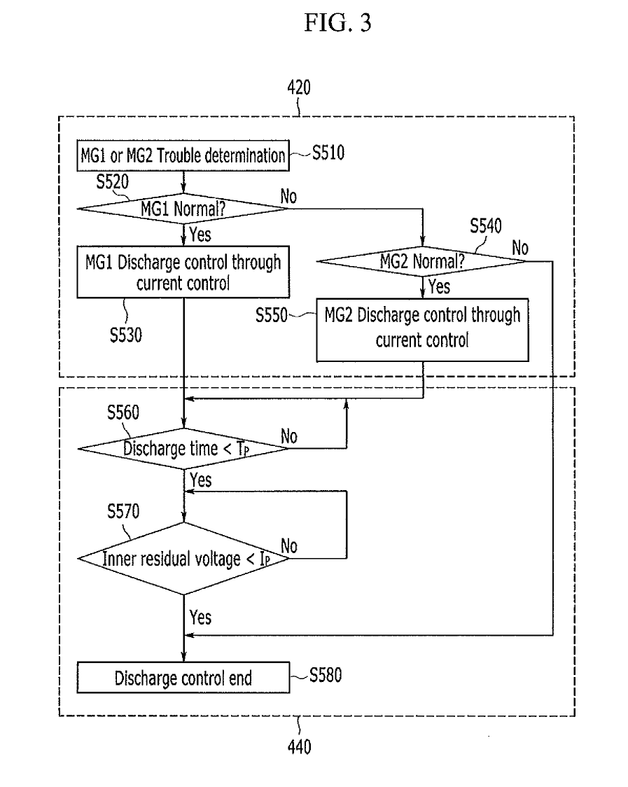

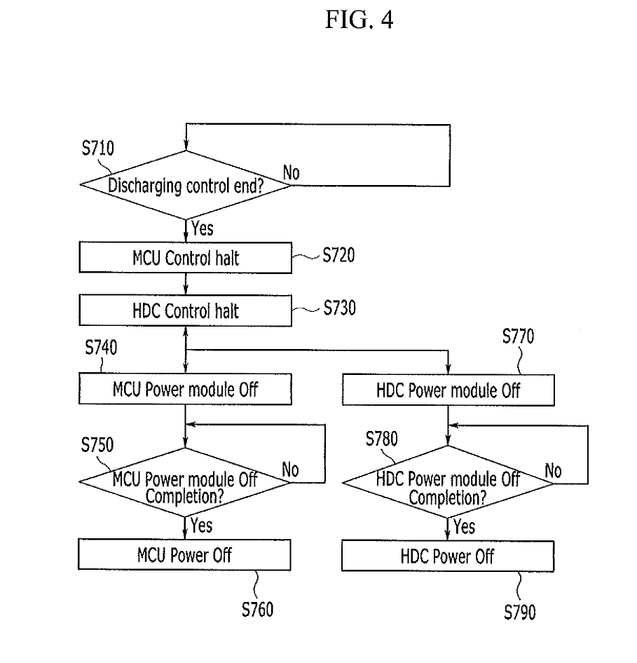

FIG. 2 is a flowchart for controlling discharge according to an exemplary embodiment of the present invention. FIG. 3 is a control flowchart of a discharge control performance determiner 420 and a control end determiner 440 through a motor according to an exemplary embodiment of the present invention, and FIG. 4 is a control flowchart in a shutdown control unit 500 according to an exemplary embodiment of the present invention, and hereinafter, referring to FIG. 2 to FIG. 4, this invention will be described.

First, a vehicle is stopped by a driver and the key is drawn out of a key box to turn off the vehicle in S100. After the ignition is turned off, the torque of a motor is controlled to be 0 in S200 to cause a charge/discharge power of a motor to also be 0. As a result, a main relay 110 of the high voltage battery 100 is not melted when the input and output sides of the high voltage battery 100 are blocked in S300. The melting of the main relay 110 signifies that the main relay 110 is melted by an arc and sticks the relay 110 to a connection portion while the main relay 110 is being operated. If the motor torque is not controlled to be 0 and the charge/discharge power does not become 0, the charged current can be supplied through the main relay 110 and the main relay 110 can be melted thereby.

After the main relay 110 of the high voltage battery 100 is blocked, a discharge switch 220 of the high voltage DC-DC converter 200 is turned on in S400. This operation applies a high voltage path to a component in which voltage of high voltage component such as DC/DC converter and inverter resides. Accordingly, the component in which that voltage resides is simultaneously discharged when the residual current is discharged.

The discharge of the residual high voltage is performed by a discharge control unit 400, and the discharge control unit 400 determines which one of the motors is to be operated through a discharge control performance determiner 420 in S500.

Referring to FIG. 3, this principle will be more specifically described.

First, it is determined whether the first and second motors 310 and 330 are malfunctioning or not in S510, and when it is determined that the first motor 310 is being normally operated in S520, the current is discharged through current control using the first motor 310 in S530. However, when the first motor 310 is being abnormally operated or is malfunctioning, it is determined whether the second motor 330 is being normally operated or not, and when it is determined that the second motor is being normally operated in S540, the current is discharged through a current control using the second motor 330 in S550. Further, when it is determined that the first and second motors are being abnormally operated or are malfunctioning, the discharge control is terminated in S580 and a warning signal to the driver is activated.

In the above, it is described that either the first motor 310 or the second motor 330 is being operated to discharge the residual current, however, as previously described, the first and second motors 310 and 330 can both be operated to discharge the residual current. Also, when the system is provided with more than two motors, all or some of the motors can be operated to discharge the residual current.

The discharge control using the motor according to an exemplary embodiment of the present invention uses a current control method using a synchronous reference frame that is known to a person of ordinary skill in the art, in which a D axis current and a Q axis current are input to calculate V_{ds} and V_{qs} as a voltage order, and this is transformed to a voltage that is applied to a three-phase electrical system through a coordinate frame change, wherein the torque of the motor is not generated by the flowing current. This transformation system is well-known to a person of ordinary skill in the art, and therefore detailed descriptions thereof will be omitted.

After the motor that is to operate discharge control is selected and the discharge control is started, the discharge control end determiner 440 determines whether discharge control has completed or not.

Referring to FIG. 3, a discharge time is compared with a predetermined value (Tₚ) in S560, when the discharge time is less than the predetermined time, it is determined that the discharge control has normally completed, and the residual voltage is compared with a predetermined value (Iₚ) in S570. Further, when the residual voltage does not descend to a voltage less than a predetermined value for a predetermined time, it is determined that a voltage of the high voltage battery 100 has been discharged and the discharge control has ended thereby preventing the main relay 110 of the high voltage battery 100 from being melted.

When the residual voltage is less than a predetermined value, it is determined that discharge control is being normally operated and the discharge control is ended in S580. When a discharge control ends, shutdown control is performed, wherein the shutdown control will be described referring to FIG. 4 that shows a flowchart in a shutdown control unit 500 according to an exemplary embodiment of the present invention.

The shutdown control unit 500 is performed through control of the motor controller 300 and the high voltage DC-DC converter 200. If the discharge control terminates in S710, the current control of the motor controller 300 is also terminated and the switch of the pulse-width modulator (PWM) is turned off in S720. After this, the PWM switch is turned off to terminate the discharge control by the discharge switch 220 in S730. That is, the control of the high voltage DC-DC converter 200 is terminated.

Thereafter, the power modules (220, 240, 320, and 340) of the motor controller 300 and the high voltage DC-DC converter 200 are turned off in S740 and S770 such that the control is completed. In this case, after the power modules (220, 240, 320, and 340) of the motor controller 300 and the high voltage DC-DC converter 200 are turned off, a delay time until a real power down condition(stage) can be generated occurs, and after the power down condition of the power module (220, 240, 320, and 340) is confirmed in S750 and S780 and the power down condition of the motor controller 300 and the high voltage DC-DC converter 200 is confirmed, the power of the motor controller 300 and the high voltage DC-DC converter 200 is turned off in S760 and S790.

All the discharge control is completed by doing so.

In accordance with an exemplary embodiment of the present invention, since at least two motors and power modules are respectively used, the discharge control can be performed even if one of the motors or the power modules is abnormally operated or malfunctions.

Furthermore, the above described processes and methods may be performed by control logic embodied as computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: high voltage battery
110: main relay
150: battery controller (BMS)
200: high voltage DC/DC converter
220: discharge switch
240: charging switch
300: motor controller (MCU)
310: first motor
320: first motor power module
330: second motor
340: second motor power module
400: discharge control unit
420: discharge control performance determiner
440: discharge control end determiner
500: shutdown control unit

What is claimed is:

1. A system for discharging a residual high voltage of a hybrid vehicle, comprising:
a high voltage battery and a battery controller configured to control the high voltage battery;
a high voltage DC-DC converter (HDC) connected to the high voltage battery and configured to charge or discharge the high voltage battery;
a motor controller connected to the high voltage DC-DC converter to control at least one motor;
a discharge control unit connected to the motor controller to discharge the residual high voltage through the motor; and
a shutdown control unit that turns off the high voltage DC-DC converter and the motor controller when the discharge control terminates.

2. The system for discharging a residual high voltage of claim 1, wherein the discharge control unit includes a discharge control performance determiner configured to select a motor for performing discharge control when two motors are installed in the hybrid vehicle.

3. The system for discharging a residual high voltage of claim 1, wherein the discharge control unit includes a discharge control ending unit configured to compare the discharge time and an inner residual voltage with a predetermined value and terminate the discharge control.

4. The system for discharging a residual high voltage of claim 1, wherein the shutdown control unit is configured to terminates operation of the motor controller and control of the high voltage DC-DC converter to complete a shutdown sequence.

5. A method for discharging a residual high voltage of a hybrid vehicle, comprising:
determining, by a control, unit that the hybrid vehicle is off;
blocking, by a relay, input and output power of a high voltage battery;
discharging, by a first unit, a residual high voltage by closing a discharge switch of a high voltage DC-DC converter; and
controlling, by a second unit, shutdown of a controller and the high voltage DC-DC converter, when the discharge control terminates.

6. The method for discharging a residual high voltage of claim 5, wherein the residual high voltage is discharged by operating at least one motor.

7. The method for discharging a residual high voltage of claim 6, further comprising determining which of the motors is to be operated, before the residual high voltage is discharged.

8. The method for discharging a residual high voltage of claim 5, further comprising determining whether the discharge time is longer than a predetermined value, while the residual high voltage is discharged.

9. The method for discharging a residual high voltage of claim 5, further comprising determining whether a residual voltage is larger than a predetermined value, when the residual high voltage is discharged.

10. The method for discharging a residual high voltage of claim 5, wherein the shutdown control terminates current control of the motor controller and control of the high voltage DC-DC converter, and turns off the motor controller and the high voltage DC-DC converter.

11. A computer readable medium containing program instructions executed by a controller, the computer readable medium comprising:
program instructions that control a relay to block input and output power of a high voltage battery once a vehicle is turned off or a collision occurs;
program instructions discharge a residual high voltage by closing a discharge switch of a high voltage DC-DC converter; and
program instructions that control shutdown of a controller and the high voltage DC-DC converter, when the discharge control terminates.

12. The computer readable medium of claim 11, wherein the residual high voltage is discharged by operating at least one motor.

13. The computer readable medium claim 12, further comprising program instructions that determine which of the motors is to be operated, before the residual high voltage is discharged.

14. The computer readable medium claim 11, further comprising program instructions that determine whether the discharge time is longer than a predetermined value, while the residual high voltage is discharged.

15. The computer readable medium claim 11, further comprising program instructions that determine whether a residual voltage is larger than a predetermined value, when the residual high voltage is discharged.

16. The computer readable medium of claim 11, wherein the program instructions that control shutdown terminate current control of the motor controller and control of the high voltage DC-DC converter, and turns off the motor controller and the high voltage DC-DC converter.

17. The computer readable medium of claim 11, further comprising program instructions that monitor the current being discharged through the motor and control a discharge amount per hour when a high capacity capacitor is applied.
